(19) United States
(12) Patent Application Publication
(10) Pub. No.: US 2003/0014426 A1
(43) Pub. Date: Jan. 16, 2003

(54) System and method for communicating aircraft and aircraft engine information

(76) Inventors: Norman Wesley Gimbert, Cincinnati, OH (US); Brandon Christopher North, Cincinnati, OH (US); Stevan M. Talevksi, Cincinnati, OH (US)

Correspondence Address: John S. Beulick, Armstrong Teasdale LLP, One metropolitan Sq., Suite 2600, St. Louis, MO, 63102, US

(21) Appl. No.: 09/903,474

(22) Filed: Jul. 11, 2001

(51) Int. Cl. G06F 7/00

(52) U.S. Cl. 707/104.1

(57) ABSTRACT

A system enables aircraft and aircraft engine information to be communicated to a user via a computer including a browser. The system includes a first server system and a second server system. The first server system includes a first web server and a first database that is coupled to the first database. The first web server is configured to cause to be displayed at the user computer at least one web page populated with data from the first database. The second server system includes a second web server and a second database that is coupled to the second database. The second web server is configured to cause to be displayed at the user computer at least one web page populated with data from the second database. Data stored in the first server system database accessible to the user browser via the second server system.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever

### BACKGROUND OF THE INVENTION

This invention relates generally to communication systems and more particularly, to a system and method for communicating aircraft and aircraft engine information.

During engine development, an aircraft engine manufacturer and an associated aircraft or airframe manufacturer may collaborate extensively. More specifically, often confidential information is shared between the two business entities during development of the engine and/or airframe. Often such information is exchanged via fax, express mail, and occasionally electronically through e-mail. Over the course of engine and/or airframe development, volumous amounts of information may be exchanged. Because such information is often time-sensitive or frequently updated, maintaining document integrity and version control is essential, and may be a tedious and difficult task for a business entity during the course of engine development. Additionally, as the amount of information exchanged increases, the difficulty of maintaining security of the information may also be a difficult task for the business entity.

To facilitate expediting the information exchange while minimizing the amount of information that is physically exchanged, at least some known business entities have attempted to share engine information in a central, paperless environment. More specifically, databases including complex security protocol systems that limit access to the data have been developed. Such databases may be expensive and central databases that are freely accessible by both business entities may not enable one or both of the business entities to adequately control access to their proprietary information. As a result, to facilitate maintaining control of their proprietary information, often the business entities mandate that all of the data be physically stored on their server system. Physically storing the information on only one server system facilitates the business entity maintaining control of the proprietary information, but may hampen the exchange of information since such systems provide users from the second business entity only limited access to the information.

### BRIEF SUMMARY OF THE INVENTION

In one aspect of the invention, a system for communicating aircraft and aircraft engine information to a user via a computer including a browser is provided. The system includes a first server system and a second server system. The first server system includes a first web server and a first database. The first web server is coupled to the first database, and the first web server is configured to cause to be displayed at the user computer at least one web page populated with data from the first database. The second server system includes a second web server and a second database. The second web server is coupled to the second database, and the second web server is configured to cause to be displayed at the user computer at least one web page populated with data from the second database. Data stored in the first server system database accessible to the user browser via the second server system.

In another aspect, a database structure that is configured to be protected from access by unauthorized individuals is provided. The database structure includes a first database and a second database. The first database is coupled to a first server system that is hosted by an aircraft engine manufacturer, and the second database is coupled to a second server system hosted by a business partner of the aircraft engine manufacturer. At least one of the first database and the second database includes information relating to at least one of general information, plans and schedules, propulsion systems, and engineering. The first database is also linked to a first web page that is configured to be populated with data from the first database. The second database is linked to a second web page that is configured to be populated from the second database.

In a further aspect of the present invention, a web-based communications system is provided. The communications system includes a computer including a browser, a network coupled to the computer, a first server system, and a second server system. The first server system includes a first web server and a first database. The first web server is coupled to the first database and to the network. The first web server is configured to cause to be displayed at the user computer at least one web page populated with data from the first database. The second server system includes a second web server and a second database. The second web server is coupled to the second database and to the network. The second web server is configured to cause to be displayed at the user computer at least one web page populated with data from the second database. Data stored in the first server system database accessible to the user browser via the second server system.

In another aspect, a method for communicating aircraft and aircraft engine information using a system including a first server system and a second server system is provided. The first server. system includes a first web server and a first database. The second server system includes a second web server and a second database. The method includes the steps of coupling the first web server to the first database, accessing at least one web page populated with data from the first database via a computer including a browser, coupling the second web server to the second database, accessing at least one web page populated with data from the second database via the computer browser, and selectively accessing data stored in the first server system database via the second server system.

### BRIEF DESCRIPTION OF THE DRAWINGS

FIG. 1 is a system block diagram illustrating an exemplary system for communicating aircraft engine and aircraft information;

FIG. 2 is a system block diagram illustrating an exemplary sub-system that may be used with the system shown in FIG. 1;

FIG. 3 is an expanded version block diagram of an exemplary embodiment of a server architecture of a sub-system that may be used with the system shown in FIG. 1;

FIG. 4 is an exemplary embodiment of a web page that may be used with the system shown in FIG. 3; and

FIG. 5 is an alternative exemplary embodiment of a web page that may be used with the system shown in FIG. 3.

### DETAILED DESCRIPTION OF THE INVENTION

Exemplary embodiments of systems and processes that facilitate communicating aircraft and aircraft engine information are described below in detail. The systems and processes are not limited to the specific embodiments described herein, but rather, components of each system and each process can be practiced independently and separately from other components and processes described herein. Each component and process can also be used in combination with other components and processes.

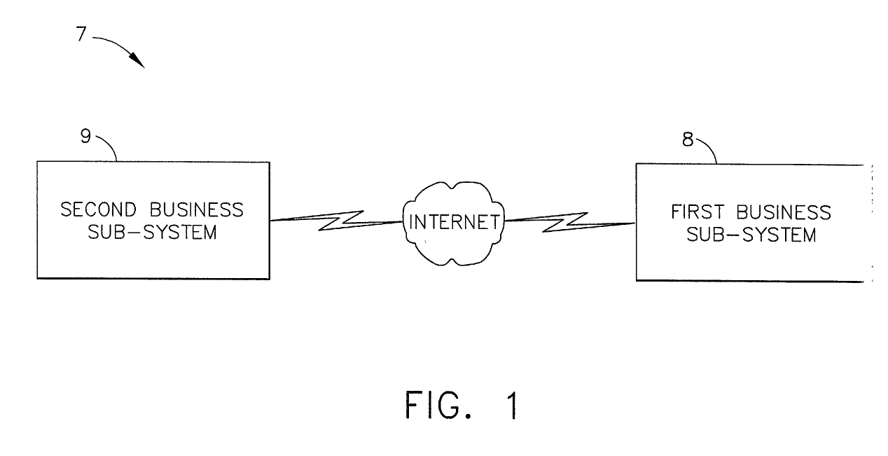

FIG. 1 is a system block diagram illustrating an exemplary system 7 for communicating aircraft engine and aircraft information. System 7 includes a first sub-system 8 and a second sub-system 9 coupled through the Internet. Sub-system 8 is substantially similar to sub-system 9 and includes a plurality of components (not shown in FIG. 1) that are identical with components (not shown in FIG. 1) utilized with sub-system 9. In the exemplary embodiment, sub-system 8 is hosted by a first business entity, and sub-system 9 is hosted by a second business entity. Accordingly, sub-system 8 includes information stored a first database (not shown in FIG. 1) that is considered proprietary to the first business entity, and sub-system 9 includes information stored in a second database (not shown in FIG. 1) that is considered proprietary to the second business entity. In one embodiment, the first business entity is an aircraft engine manufacturer, such as General Electric Company, Cincinnati, Ohio, and the second business entity is an aircraft manufacturer. Alternatively, the second business entity may be, but is not limited to, a business partner, a supplier, or a customer of the aircraft engine manufacturer.

System 7, enables the first and second businesses to communicate and collaborate in a centralized, paperless environment. However, because each business entity hosts their own data on their own server and sub-system, proprietary data integrity and control is maintained. System 7 operates by creating two independently hosted web sites (not shown in FIG. 1) that are synchronized to function as a collaborative web site. More specifically, system 7 coordinates the content and navigation on each business entity's server. Accordingly, the business entities agree to a common navigation structure and to common content upload rules. Furthermore, the business entities agreed to a common platform for maintaining user permissions across the web sites to ensure that users from each business entity have equal functionality within system 7.

Each sub-system 8 and 9 accumulates a variety of data for numerous aircraft engines and aircraft that is highly confidential. Therefore, each sub-system 8 and 9 has different access levels to further control and monitor the security of system 7. Authorization for access is assigned by system administrators on a need to know basis. In an alternative embodiment, system 7 provides access based on job functions. In yet another embodiment of the invention, system 7 provides access based on positions and management authority within each business entity. The editing capabilities within system 7 are also restricted to ensure that only authorized individuals have access to modify or edit the information that is already existing in the system. These internal controls with reference to system security help system 7 to manage and control the access to the information.

Each business entity hosts approximately half of the navigational pages that are accessible through system 7. Each navigational page includes links to data stored on each entities respective servers. The pages are coordinated such that the navigational structure is substantially identical for each business entity's users.

System 7 enables aircraft and aircraft engine information to be communicated to a user via a computer (not shown in FIG. 1) including a browser. Sub-system 8 includes a first server system (not shown in FIG. 1). The first server system includes a first web server and a first database that is coupled to the first web server. The first web server is configured to cause to be displayed at the user computer at least one web page populated with data from the first database. Sub-system 9 includes a second server system (not shown in FIG. 1). The second server system includes a second web server and a second database that is coupled to the second web server. The second web server is configured to cause to be displayed at the user computer at least one web page populated with data from the second database. System 7 enables data stored in the first server system database to be accessible to the user browser via the second server system. Accordingly, navigational pages may be populated with data from the first web server, the second web server, or a combination of the two web servers. As such, the navigational structure is seamless to each user.

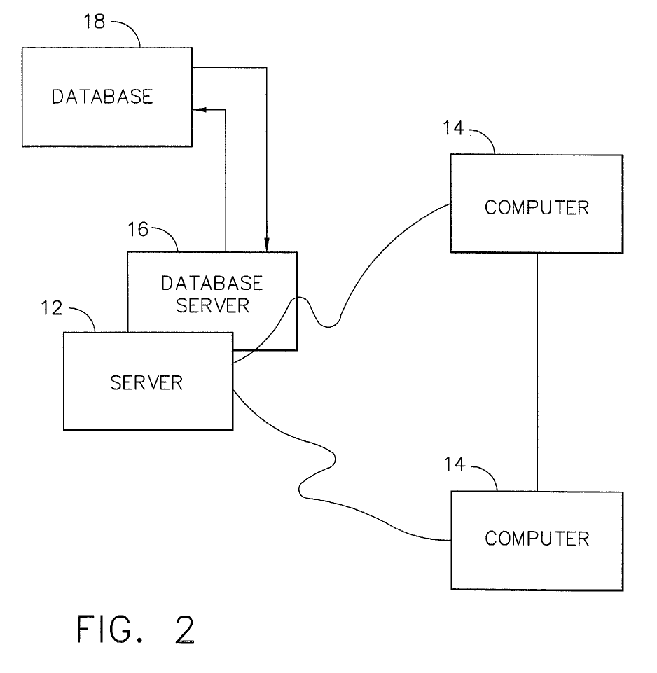

FIG. 2 is a system block diagram illustrating an exemplary sub-system 10 that may be used with system 7 (shown in FIG. 1). In one embodiment, sub-system 10 is identical with sub-system 8 (shown in FIG. 1) and is hosted by an aircraft engine manufacturer. In another embodiment, sub-system 8 is identical with sub-system 9 (shown in FIG. 1) and is hosted by an aircraft manufacturer. Sub-system 10 may be used to populate a web page used by aircraft and aircraft engine communications system 7. System 10 includes a server 12 and a plurality of devices 14 connected to server 12. In one embodiment, devices 14 are computers including a common web browser, and server 12 is accessible to devices 14 via the Internet. In an alternative embodiment, devices 14 are servers for a network of customer devices. System 10 is coupled to a mass storage device (not shown). In the exemplary embodiment, server 12 includes a database server 16 coupled to a database 18. In one embodiment, database 18 includes information considered proprietary to the aircraft engine manufacturer. In an alternative embodiment, database 18 includes information considered proprietary to a business partner of the aircraft engine manufacturer.

Devices 14 are interconnected to the Internet through many interfaces including through a network, such as a local area network (LAN) or a wide area network (WAN), through dial-in-connections, cable modems and special high-speed ISDN lines. Alternatively, devices 14 could be any device capable of interconnecting to the Internet including a web-based phone or other web-based connectable equipment.

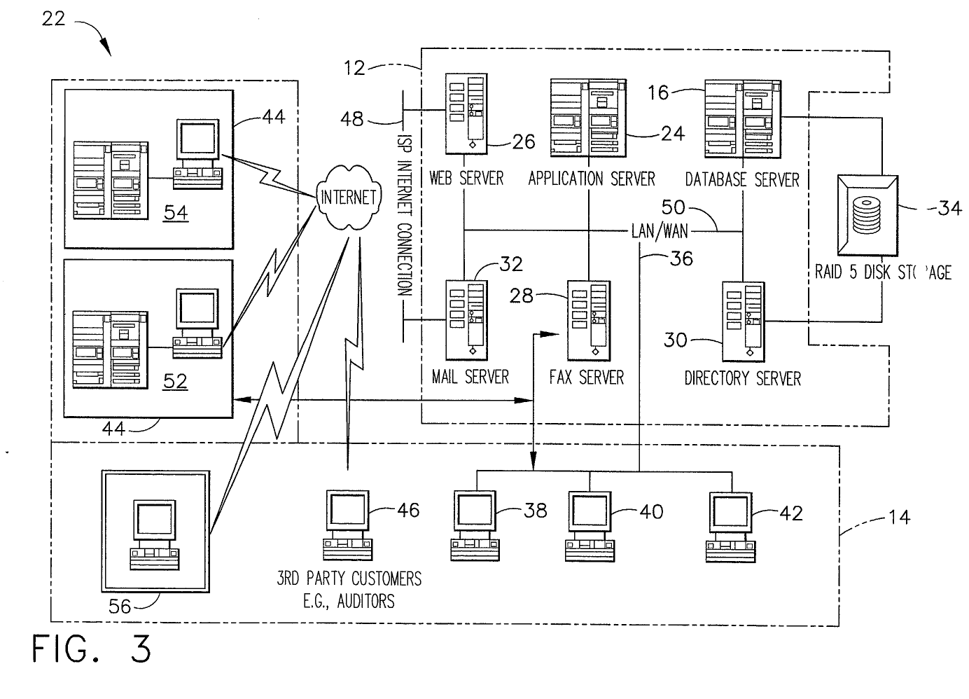

FIG. 3 is an expanded version block diagram of an exemplary embodiment of a server architecture of a sub-system 22 that may be used with system 7 (shown in FIG. 1). In one embodiment, sub-system 22 is identical with sub-system 8 (shown in FIG. 1) and is hosted by an aircraft engine manufacturer. In another embodiment, sub-system 22 is identical with sub-system 9 (shown in FIG. 1) and is hosted by an aircraft manufacturer. Sub-system 22 may be used to populate a web page used by aircraft and aircraft engine communications system 7. Components of sub-system 22, identical to components of sub-system 10 (shown in FIG. 2), are identified in FIG. 2 using the same reference numerals as used in FIG. 2. Sub-system 22 includes server system 12 and user devices 14. Server system 12 includes database server 16, an application server 24, a web server 26, a fax server 28, a directory server 30, and a mail server 32. A disk storage unit 34 is coupled to database server 16 and directory server 30. Servers 16, 24, 26, 28, 30, and 32 are coupled in a local area network (LAN) 36. In addition, a system administrator workstation 38, a user workstation 40, and a supervisor workstation 42 are coupled to LAN 36. Alternatively, workstations 38, 40, and 42 are coupled to LAN 36 via an Internet link or are connected through an intranet.

Each workstation 38, 40, and 42 is a personal computer having a web browser. Although the functions performed at the workstations typically are illustrated as being performed at respective workstations 38, 40, and 42, such functions can be performed at one of many personal computers coupled to LAN 36. Workstations 38, 40, and 42 are illustrated as being associated with separate functions only to facilitate an understanding of the different types of functions that can be performed by users having access to LAN 36.

In another embodiment, server system 12 is configured to be communicatively coupled to various individuals or employees 44 and to users 46 via an ISP Internet connection 48. The communication in the exemplary embodiment is illustrated as being performed via the Internet, however, any other wide area network (WAN) type communication can be utilized in other embodiments, i.e., the systems and processes are not limited to being practiced via the Internet. In addition, and rather than a WAN 50, local area network 36 could be used in place of WAN 50.

In the exemplary embodiment, any authorized individual or an employee of the business entity having a workstation 52 can access server sub-system 12. One of user devices 14 includes a senior manager's workstation 54 located at a remote location. Workstations 52 and 54 are personal computers having a web browser. Also, workstations 52 and 54 are configured to communicate with server sub-system 12. Furthermore, fax server 28 communicates with employees located outside the business entity and any of the remotely located user systems, including a user system 56 via a telephone link. Fax server 28 is configured to communicate with other workstations 38, 40, and 42 as well.

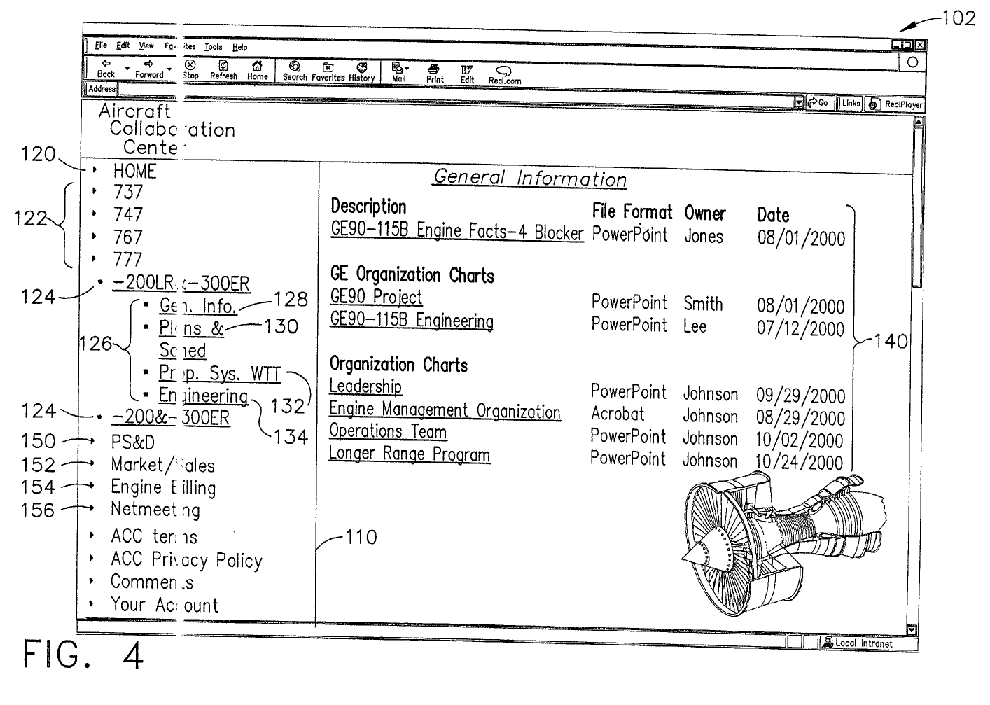

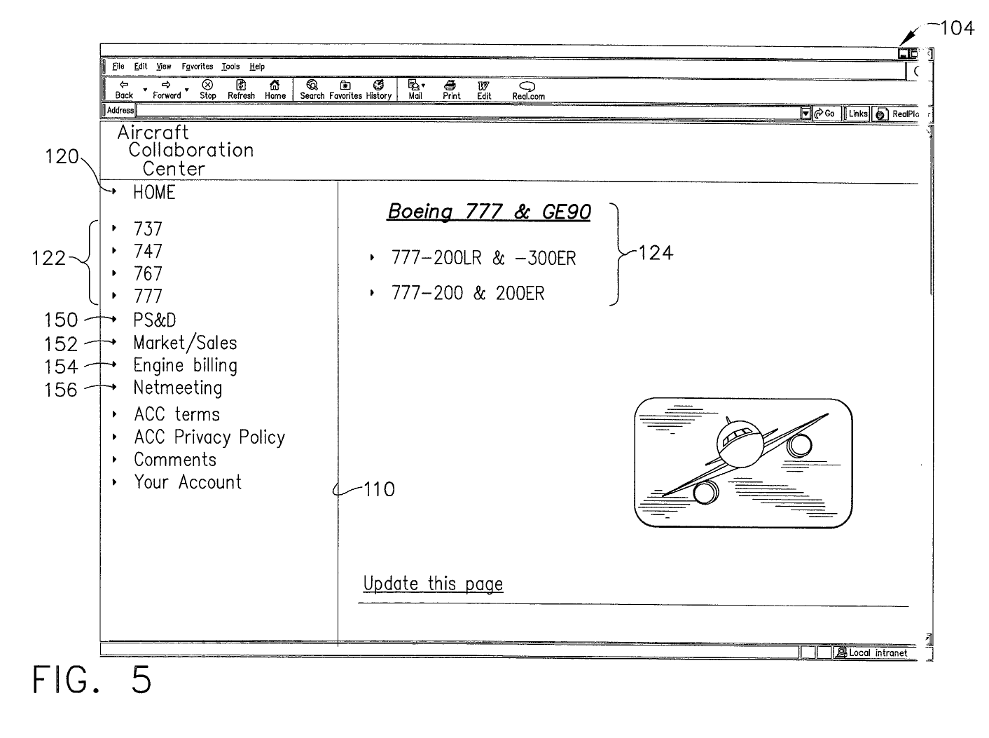

FIG. 4 is an exemplary embodiment of a web page 102 that may be used in executing system 7 (shown in FIG. 1). FIG. 5 is an exemplary alternative embodiment of a web page 104 that may be used in executing system 7. Web pages 102 and 104 are independently hosted web sites that are synchronized to function as a collaborative web site. More specifically, in the exemplary embodiments, web page 102 is populated with data from a server hosted by an aircraft engine manufacturer, and web page 104 is populated with data from a server hosted by an aircraft manufacturer.

Navigation through each web page 102 and 104 is coordinated to be identical. Specifically, each web page 102 and 104 includes a navigational bar 110 that includes a plurality of hyperlinks 112 to other navigational web pages. More specifically, each business entity hosts approximately half of the navigational pages that are accessible from web pages 102 and 104, and several of the links provide access to stored on each entities respective servers. Accordingly, data stored in a first business entity's server system database is accessible to a user browser via a second server system, or vice-versa.

In the exemplary embodiment, each navigational bar 110 includes a link 120 to a home page, and a plurality of links 122 directed to various aircraft which use engines manufactured by the engine manufacturer. Selecting a specific aircraft using links 122 enables a user to select a specific model/series of the aircraft selected with links 124. For example, selecting “777” enables a user to select between a 777-200LR &-300ER series, or 777-200 & 200ER series of aircraft. Selecting a specific model/series of aircraft with links 124 enables a user to view information pertaining to the specific model/series of aircraft selected using hyperlinks 126. More specifically, links 126 include a link 128 for general information, a link 130 for plans and scheduling, a link 132 for propulsion systems, and a link 134 for engineering.

Each hyperlink 126 selected enables a user to view additional information that is more specific to the item selected. For example, selecting general information link 128 enables a user to select additional links 140 pertaining to general information. More specifically, links 140 include, but are not limited to, general descriptions of an engine associated with the aircraft selected, organization charts of personnel assigned to the associated engine design, and organization charts of personnel assigned the associated aircraft.

Navigation bar 110 also includes a link 150 to E & D (engineering and design), a link 152 to marketing/sales, a link 154 to engine billing, and a link 156 for netmeeting. Changes in the navigational structure of web pages 102 and 104 are documented and maintained in a spreadsheet format that is accessible through navigation bar 110. More specifically, all navigation change details, a url of the page changed, and a controlling party of the page are stored in an historical log.

Users access web pages 102 and 104 after entering information in a login screen (not shown). Login requires the user to enter a username and a password. The login serves several purposes including, but not limited to, allowing system 7 to be accessed over the Internet while maintaining security concerns. Additionally, the login enables the user to access features specific to the user's role on the project, and enables a record to be maintained of work performed against the name of the user in the event the user is required to be contacted. In addition to maintaining the security of the system, the user login is also used to identify tasks performed within the system, including navigational upgrades. Each sub-system 8 and 9 accumulates a variety of data for numerous aircraft engines and aircraft that is highly confidential. Therefore, each sub-system 8 and 9 has different access levels to further control and monitor the security of system 7. Authorization for access is assigned by system administrators.

While the invention has been described in terms of various specific embodiments, those skilled in the art will recognize that the invention can be practiced with modification within the spirit and scope of the claims.

What is claimed is:

1. A method for communicating aircraft and aircraft engine information using a system including a first server system and a second server system, the first server system including a first web server and a first database, the second server system including a second web server and a second database, said method comprising the steps of:
coupling the first web server to the first database;
accessing at least one web page populated with data from the first database via a computer including a browser;
coupling the second web server to the second database;
accessing at least one web page populated with data from the second database via the computer browser; and
selectively accessing data stored in the first server system database via the second server system.

2. A method in accordance with claim 1 wherein said step of coupling the first web server to the first database further comprises the step of providing a first server system hosted by an aircraft engine manufacturer.

3. A method in accordance with claim 1 wherein said step of coupling the second web server to the second database further comprises the step of providing a second server system hosted by an aircraft manufacturer.

4. A method in accordance with claim 1 wherein said step of selectively accessing data stored in the first server system further comprises the step of selectively accessing data from the first and second server systems based on individual access privileges.

5. A method in accordance with claim 1 wherein said step of selectively accessing data stored in the first server system further comprises the step of selectively accessing at least one of aircraft engine and aircraft data relating to at least one of general information data, plans and schedules data, propulsion systems data, and engineering data.

6. A system for communicating aircraft and aircraft engine information to a user via a computer including a browser, said system comprising:
a first server system comprising a first web server and a first database, said first web server coupled to said first database, said first web server configured to cause to be displayed at the user computer at least one web page populated with data from said first database;
a second server system comprising a second web server and a second database, said second web server coupled to said second database, said second web server configured to cause to be displayed at the user computer at least one web page populated with data from said second database, data stored in said first server system database accessible to the user browser via said second server system.

7. A system in accordance with claim 6 wherein said data stored in said first server system and said second server system accessible to the user browser based on based on individual access privileges.

8. A system in accordance with claim 6 wherein said first server system hosted by a turbine engine manufacturer, said second server system hosted by a business partner of the turbine engine manufacturer.

9. A web-based system in accordance with claim 7 wherein at least one of said first database and said second database includes aircraft data relating to at least one of general information, plans and schedules, propulsion systems, and engineering.

10. A web-based system in accordance with claim 7 wherein at least one of said first database and said second database includes aircraft engine data relating to at least one of general information, plans and schedules, propulsion systems, and engineering.

11. A web-based system in accordance with claim 7 wherein at least one of said first database and said second database maintains a record of navigation changes.

12. A database structure configured to be protected from access by unauthorized individuals, said database structure comprising a first database and a second database, said first database coupled to a first server system hosted by an aircraft engine manufacturer, said second database coupled to a second server system hosted by a business partner of the aircraft engine manufacturer, at least one of said first database and said second database including information relating to at least one of general information, plans and schedules, propulsion systems, and engineering, said first database linked to a first web page configured to be populated with data from said first database, said second database linked to a second web page configured to be populated from said second database.

13. A web-based communications system comprising:
a computer comprising a browser;
a network coupled to said computer;
a first server system comprising a first web server and a first database, said first web server coupled to said first database and to said network, said first web server configured to cause to be displayed at said computer at least one web page populated with data from said first database; and
a second server system comprising a second web server and a second database, said second web server coupled to said second database and to said network, said second web server configured to cause to be displayed at said computer at least one web page populated with data from said second database, data stored in said first server system database selectively accessible to said browser via said second server system.

14. A system in accordance with claim 13 wherein said first server system hosted by an aircraft engine manufacturer, said second server system hosted by an aircraft manufacturer.

15. A system in accordance with claim 14 wherein data stored in said first server system and data stored within said second server system selectively accessible to said browser based on based on individual access privileges.

16. A system in accordance with claim 14 wherein said browser configured to selectively display aircraft engine data relating to at least one of general information data, plans and schedules data, propulsion systems data, and engineering data.

17. A system in accordance with claim 14 wherein said browser configured to selectively display an historical log relating to navigational changes to said user interface.

18. A system in accordance with claim 14 wherein said browser configured to selectively display aircraft data relating to at least one of general information data, plans and schedules data, propulsion systems data, and engineering data.
